(19) United States
(12) Patent Application Publication
(10) Pub. No.: US 2003/0007709 A1
(43) Pub. Date: Jan. 9, 2003

(54) Internal bearing for screw machines

(76) Inventors: Norbert Schweigler, Leverkusen (DE); Hartmut Gobel, Langenfeld (DE); Thomas-Oliver Neuner, Leverkusen (DE)

Correspondence Address: BAYER CORPORATION, PATENT DEPARTMENT, 100 BAYER ROAD, PITTSBURGH, PA, 15205, US

(21) Appl. No.: 10/187,936

(22) Filed: Jul. 2, 2002

(30) Foreign Application Priority Data
Jul. 5, 2001 (DE) 10132688.2

(51) Int. Cl. F16C 19/30

(52) U.S. Cl. 384/619

(57) ABSTRACT

Screw machines having a special internal bearing for the screw shaft, which bearing eliminates the wear of cantilevered screws of single- or multi-shaft screw machines, are described. One or more additional movable bearings, which support the screw shaft and are arranged, spaced from the drive bearing, along the screw shaft, are fitted in the screw machine, the movable bearings having bearing shells of two or more parts and bearing holders of two or more parts.

### FIELD OF THE INVENTION

The invention relates to screw machines having a special internal bearing for the screw shaft, in which the bearing eliminates the wear of cantilevered screws in single- or multi-shaft screw machines. One or more additional movable bearings, which support the screw shaft and are arranged, spaced from the drive bearing, along the screw shaft, are fitted in the screw machine, the movable bearings having bearing shells of two or more parts and bearing holders of two or more parts.

### BACKGROUND OF THE INVENTION

The screw shafts of conventionally designed screw machines are often cantilevered, i.e. supported at one end, in order to be able to extrude and pelletize the product to be conveyed or treated by the screw machine, at the end of the screw machine opposite the bearing, in a manner undisturbed by shaft fittings, seals, etc. In this case, so-called auxiliary bearings are then additionally employed along the shaft. These are formed by the interaction of screw elements, mostly peripherally hardened elements, and likewise hardened, interchangeable bearing bushes with relatively high bearing clearance (also referred to as inliners). The disadvantage of this is that these parts, i.e. screw elements and/or inliners, regularly have to be changed because of wear. The resulting disadvantages are the outlay involved with replacing the parts, the shutdown of the plants and the contamination of the material to be conveyed due to abrasion.

Generic screw machines are disclosed, for example, in U.S. Pat. No. 4,124,306; U.S. Pat. No. 3,672,641; EP 0605781 B1 or DE 1629136.

Screw machines supported at both ends also exist. In this case, the second bearing is arranged outside or at the end of the processing chamber. The theoretical advantage of this arrangement is that the screw elements under ideal conditions do not touch the housing or the inliners and are thus not subjected to wear. In reality, however, wear of moving parts results here as well due to possible shaft deflection, particularly in the case of long shafts, and although this wear is reduced, it is not eliminated. This arrangement also has the disadvantage that the shaft has to be passed through the product discharge area. This in turn gives rise to problems of undesired product emergence, caking of material to be conveyed and the contamination of the material to be conveyed, which requires additional cleaning steps.

Alternatively, the sealing of this second bearing must have a very elaborate design, since, on account of the process, the highest pressures prevail at this point. In addition, maintenance work on screws with 2 bearings is more involved. Modifications to the screw equipment require the removal of the second bearing before the shaft or the elements can be extracted. A further disadvantage of these designs is that the cutting device for the pellets can no longer be chosen at will. In the simplest case, the knife rotates at the speed of the shaft (fixed, slow speed) or a complex construction must be produced to enable the knife to be operated at a different, generally higher, speed. This makes structure of the screw machine even more complicated.

On account of the design, wear results in the case of such screws either on the screw flanks or the housing. To minimize this, either the screw flanks are completely or partially hardened or so-called inliners, i.e. interchangeable bushes, are used (auxiliary bearings). Nevertheless, after a certain, comparatively short operating time, these parts must be replaced. This involves a high outlay both in terms of the special replacement parts and due to the correspondingly large amount of time required for demounting. Moreover, the machine is not available for production in this period. During operation, the wear (e.g. metallic abrasion) may also lead to undesired contamination of the product with considerable adverse consequences for the end product (it may take time until this is noticed at all).

The problems with the bearings are particularly acute in the case of screw machines employed for rubber dewatering, since the rubber does not act as a lubricant due to its cohesive behavior (in contrast to other polymers which are liquifiable at high temperatures).

The object on which the invention is based is to develop a novel bearing for screw shafts which does not have the disadvantages of the known screw machines. In particular, the goal is to be able, with the aid of the novel screw machine, for example when working up rubber, to separate the aqueous rubber crumbs from the adhering water by continuous extraction in the screw, without producing increased wear and a reduced service life of the machine during this process.

In order to be able to achieve this object using the above-described screw with free discharge (and pelletizer), while avoiding the disadvantages, it was a matter of supporting a screw shaft, supported at one end, in a specific manner by introducing at least one second bearing and thus eliminating the wear, considerably lengthening the service life of the machine and markedly reducing the outlay associated with the cleaning of the machine, without detracting from the other advantages of this arrangement.

### SUMMARY OF THE INVENTION

The subject of the invention is a single- or multi-shaft screw machine comprising at least one or more screw shafts, an enclosing housing, a product inlet, a product outlet, a drive means for the rotation of the screw shafts, a drive bearing, optionally outlet openings for discharging liquids and optionally a vapor dome for removing volatile constituents, wherein one or more additional movable bearings, which support the screw shaft and are arranged, spaced from the drive bearing, along the screw shaft, are fitted in the housing, the movable bearings having a bearing ring, bearing shells of two or more parts and bearing holders of two or more parts. The bearing holders have one or more passages for the product.

### BRIEF DESCRIPTION OF THE DRAWINGS

FIG. 1 shows the schematic longitudinal section through a single-shaft screw machine with movable bearing.

FIG. 2 shows the cross-section through the apparatus of FIG. 1 in accordance with the section A-A.

FIG. 3a shows a longitudinal section through a single-shaft screw machine in the region of the bearing according to the invention.

FIG. 3b shows a longitudinal section through a single-shaft screw machine in the region of a differently shaped bearing.

### DETAILED DESCRIPTION OF THE INVENTION

If wear is present on the bearing itself, the replacement time can be considerably reduced and the costs minimized with the present invention, since the replacement parts can be fitted with greater ease and more quickly.

The screw shaft is supported in the processing chamber by introducing one or more bearings as so-called movable bearings with considerably lower bearing clearances. The shaft is thus, at least doubly supported, with all the advantages mentioned at the outset. The bearing rings are fixed either on the screw shaft or in the screw housing.

In a preferred embodiment of the screw machine, the movable bearing comprises a bearing ring on the screw shaft, split bearing shells, in particular as sliding bearings or rolling bearings, and a split bearing holder connected to the housing.

In an alternative embodiment of the present invention, the movable bearing comprises a split bearing ring connected to the housing, split bearing shells, in particular as sliding bearings or rolling bearings, and a split bearing holder connected to the screw shaft.

The bearing has the task of taking up the bearing forces which arise and transmitting them to the screw housing, of optionally bringing about an additional dewatering if the screw machine is used for dewatering rubber for example, particularly on integration of a “conical” expression step into the region of the passage in the bearing holder, and of keeping the flank clearance constant.

The problem underlying the present invention is solved by replacing part of the equipment on the screw shaft (screw element or intermediate piece, etc.) by a “genuine” bearing according to the present invention.

This bearing may be designed in particular as follows: The bearing shells are designed in particular as sliding bearings or as rolling bearings.

Suitable bearing materials are, inter alia, nonferrous metal, plastic or ceramic.

The rolling bearing may be a ball bearing, needle bearing or cylindrical-roller bearing.

For supplying or discharging lubricants and/or flushing agents, a preferred form of the screw machine may have a supply line to the bearing shells in the bearing holder or the bearing ring, if they are connected to the housing.

As an alternative to the process water, if necessary, special lubricants which are insensitive to water are useful as the bearing lubricant.

In a preferred embodiment of the screw machine, the bearing shells are designed as bearing half-shells.

In a more preferred further variant of the screw machine, the bearing holder is designed in two parts.

For discharging liquids, in particular process water, in a further preferred design of the screw machine according to the present invention, one or more strainer zones with outlet openings are provided in the housing.

To catch process liquid, in a further preferred design of the screw machine, the housing is surrounded at its periphery, at least in the region of the strainer zones, by a collector for liquid emerging from the strainer zones.

The bearing is connected to the shaft or the housing via a so-called spoked wheel for example. The product passes through the passage between the spokes in the usual way at low pressure.

The bearing employed is preferably a sliding bearing, for the following reasons:

the sliding bearing has a small installation depth. This is important in the conversion of existing machines and where there are process-engineering-related restrictions, such as small dimensions in the product chamber; in terms of the process engineering, pressure and/or flow changes may not be desired.

The simple structure of the sliding bearing enables retrofitting of existing machines and unproblematical replacement in the event of damage (use of two half-shells, especially on machines in which the housing can be swung open).

Dispensing with elaborate sealing and additional lubrication makes the sliding bearing particularly advantageous. In contrast to other products, rubber as the process product has a non-lubricating action (cohesive instead of adhesive behavior); the penetration of water is not disadvantageous in this case. It is, therefore, also possible to employ water as a special lubricant. This is not damaging, especially in the case of rubber dewatering, since the water does not mix with the rubber and can leave the machine a short distance before or after the bearing without adversely affecting the dewatering capacity of the machine.

The place where the product passes through may, however, be reduced in a controlled manner; it is thus possible to achieve dewatering effects which are desired in terms of process engineering at one and the same place (possibly even adjustable from outside or during operation). That is to say, the screw does not therefore need to be lengthened unnecessarily, which would entail not only additional costs but also, in turn, greater bearing problems (weight, length).

The support may be single, preferably about ⅔ of the way along the length of the screw because of shaft deflection, or multiple. This may be with or without the integration of expression points (cones).

The elimination of shortcomings and disadvantages presented by the use, according to the present invention, of the movable bearing affords the following advantages:

It achieves the “classical” double support, at both ends. The fixed/movable support is effected with customary (bearing) tolerances. No sealing is required in the high-pressure region. Pelletizer and free discharge (discharge chute) do not have to be dispensed with.

The solution is an add-on solution without risk, since the bushes initially remain installed, and makes expensive bearing bushes unnecessary” (hence, pure emergency running bearings). The device is considerably less expensive to purchase and maintain. The operational reliability of the machine (no contamination due to metal abrasion from bushes) increases. Old machines may be retrofitted if necessary. The device can be functionally expanded (fixed and variable cone, simultaneous bearing flushing/lubrication and sealing). The peripheral speed at the sliding surface is reduced (since the support is provided at the shaft core and not at the screw outside diameter).

The present invention may be readily applied to twin-shaft screw machines. It is thus possible to solve wear and process-engineering problems for twin-shaft screws as well.

The production of the screw shafts according to the present invention and of their wearing parts is less expensive in the bearing region, since the costly hard armoring is unnecessary. The present invention enables a simpler structure than the use of previous bearings, especially as the bearing is easily accessible, particularly in the case of screw housings which can be swung open.

The screw machines according to the present invention have a lower susceptibility to faults due to a comparatively lower bearing wear, which results in low metal abrasion. This leads to greater reliability of the screw machines according to the invention on account of a longer service life of the machines.

A higher product quality is possible by avoiding metal abrasion, since there is no contamination of the product to be conveyed; by avoiding a variable gap with respect to the housing at one or more cones and among the screw flanks, the dewatering of moist product is more uniform and there is less thermal damage to the product due to mechanical stress (caused by locally high shear rates) and thus the quality is higher; the latter applies particularly to products sensitive to shear, such as so-called HIPS-BR rubbers (high impact polystyrene butadiene rubber), which are otherwise prone to gelation.

The screw machines may be constructed in the manner customary hitherto. Special materials are not required (in the case of the bearing material, attention may have to be paid to the maximum permissible peripheral speed; this sets limits on certain materials). In the case of undivided screw housings (so-called expanders or twin-shaft screws), appropriate inserts are to be produced, the screw and shaft, for example, being jointly inserted.

Furthermore, the subject of the present invention is the use of the screw machine according to the present invention as a dewatering screw for rubber slurries, as an extruder, expeller, expander for the dewatering and/or drying of elastomers or rubber, or as an extruder for the melting, mixing, drying, compounding and further processing of elastomers, rubber and thermoplastic polymers.

The invention is explained in more detail below, with reference to the figures, using the examples, which, however, do not constitute a limitation of the invention.

### EXAMPLES

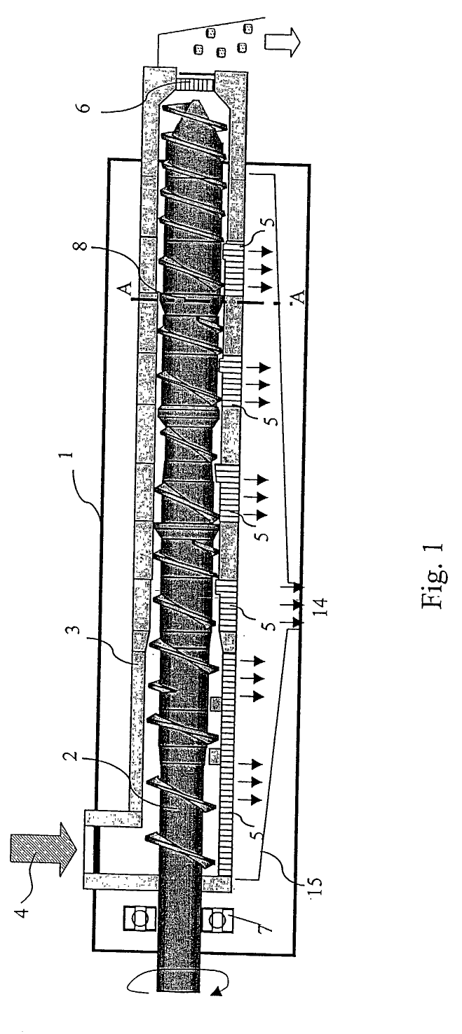

FIG. 1 shows a conventionally designed screw press 1 with screw shaft 2 and housing 3. The product (rubber slurry) enters at product inlet 4. The aqueous phase leaves the screws at the various open strainer zones 5 on the way to the perforated plate 6. The solid remains inside and is transported towards the perforated plate 6 and extruded at the latter under high pressure. Due to the sudden release of pressure upon emerging from the perforated plate 6 into the discharge area, some of the water evaporates, while the rubber is dried to the ultimate moisture in subsequent process steps. The first bearing (fixed bearing 7) is situated on the left-hand side (close to the gearing) of the screw 2. The second bearing (movable bearing 8) is arranged in the processing chamber about ⅔ of the way along the length of the shaft of the screw 2.

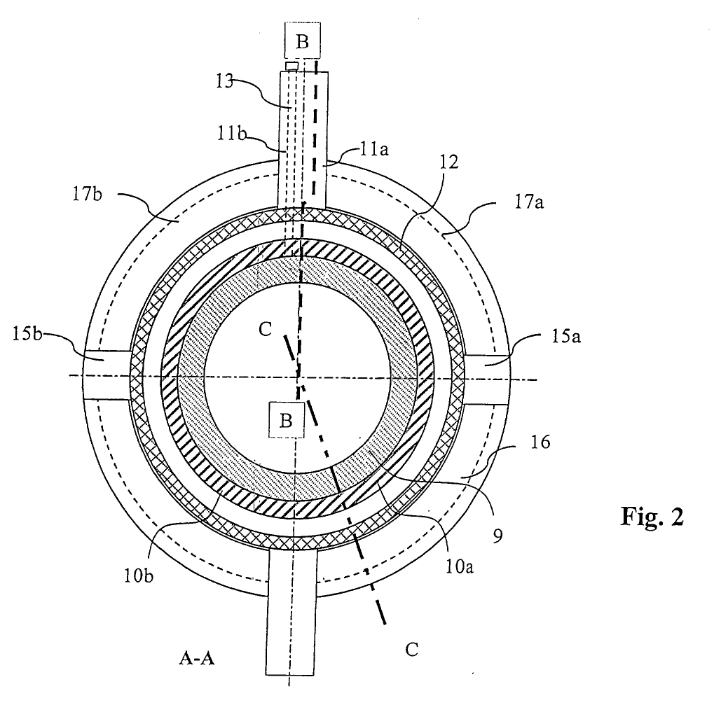

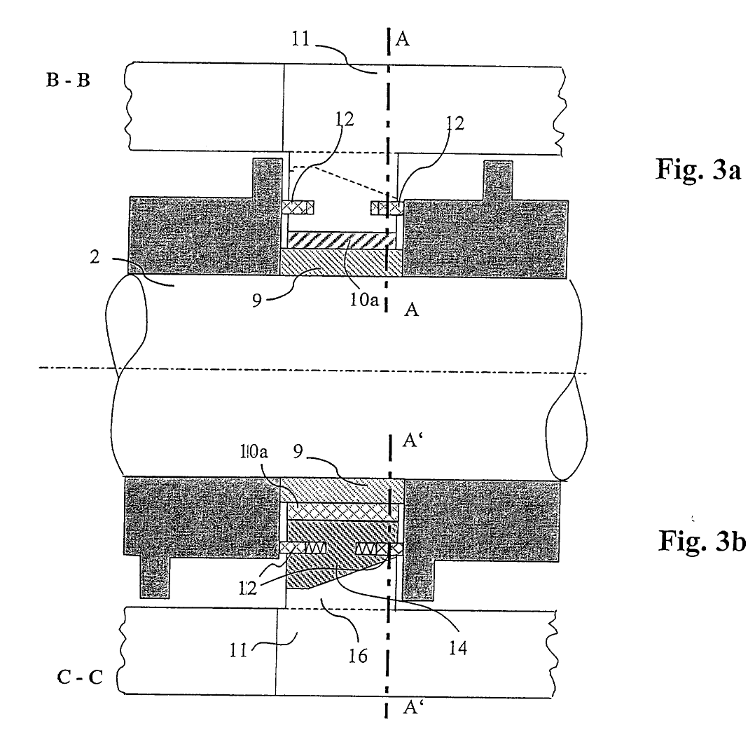

FIGS. 2 and 3 show the movable bearing 8 in detail. The movable bearing 8 (of the type consisting of a sliding bearing on a shaft) contains the bearing ring 9 close to the shaft, in which the bearing ring is fixably mounted on the shaft 2 and rotates with the shaft 2, the stationary bearing half-shells 10 and the likewise split bearing holder 11 (designed here in the form of a spoked wheel). The bearing 8 is protected from penetration of relatively coarse solid particles by a seal 12. The penetration of water does not necessarily have to be prevented, particularly in the case of applications for rubber dewatering. If necessary, however, this may be done by correspondingly more elaborate sealing.

The screw machine 1 is constructed in such a way that the machine 1 can be opened by swinging open the strainer housing 3. The movable bearing or bearings 8 are thus easily accessible for maintenance or replacement work. The bearing holder 11 has at least 2 spokes, but may also have 4 spokes (as shown) or 6 spokes (not shown), which support the shaft 2 relative to the housing 3, 2 of the spokes being fixedly connected to the strainer housing 3. The remaining spokes (15) support the shaft 2 via the inner walls.

The annular-segment-shaped interspaces between the spokes (16) may be utilized—but not all simultaneously—for the controlled extraction of water by partial or complete closure. This closure may also be performed from outside by introducing inserts when the screw machine is idle or with the use of slides. In addition, the webs 13 which are optionally fixed to the housing are used for supplying and discharging lubricants and flushing agents.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A single- or multi-shaft screw machine comprising at least one or more screw shafts, an enclosing housing, a product inlet, a product outlet, a drive means for the rotation of the screw shafts, a drive bearing, optionally at least one outlet opening for discharging liquids and optionally a vapor dome, wherein one or more additional movable bearings, which support the screw shaft and are arranged, spaced from the drive bearing, along the screw shaft, are fitted in the housing, the movable bearings comprising a bearing ring, split bearing shells of two or more parts and split bearing holders of two or more parts.

2. A screw machine according to claim 1, wherein the movable bearing comprises a bearing ring on the screw shaft, split bearing shells, in particular as sliding bearings or rolling bearings, and a split bearing holder connected to the housing.

3. A screw machine according to claim 2, wherein said split bearing shell is a sliding bearing or roller bearing.

4. A screw machine according to claim 1, wherein the movable bearing comprises a split bearing ring connected to the shaft, split bearing shells, and a split bearing holder connected to the screw shaft.

5. A screw machine according to claim 1, wherein the split bearing shells are designed as sliding bearings.

6. A screw machine according to claim 4, wherein the movable bearing comprises a material selected from the group consisting of nonferrous metal, plastic and ceramic.

7. A screw machine according to claim 3, wherein the rolling bearing is a ball bearing, needle bearing or cylindrical-roller bearing.

8. A screw machine according to claim 2, wherein a supply line to the split bearing shells for supplying or discharging lubricants and/or flushing agents is provided in the split bearing holder or the bearing ring.

9. A screw machine according to claim 1, wherein the split bearing shells are designed as bearing half-shells.

10. A screw machine according to claim 1, wherein one or more strainer zones with outlet openings for discharging liquids are provided in the housing.

11. A screw machine according to claim 10, wherein said discharging liquid is process water.

12. A screw machine according to claim 1, wherein the housing is surrounded at its periphery, at least in the region of the strainer zones, by a collector for receiving liquid emerging from the strainer zones.

13. A screw machine according to claim 1 for use as a dewatering screw for rubber slurries, as an extruder, expeller, expander for the dewatering and/or drying of elastomers or rubber, or as an extruder for the melting, mixing, drying, compounding and further processing of elastomers, rubber and thermoplastic polymers.

14. A screw machine according to claim 1, wherein at least one circular-segment-shaped interspaces may additionally be partially closed by fittings.

15. A screw machine according to claim 14, wherein said fitting is a cone.
